(19) United States
(12) Patent Application Publication
(10) Pub. No.: US 2015/0260661 A1
(43) Pub. Date: Sep. 17, 2015

(54) Sensor and Method for Recognizing an Object Located at a Roller Track

(71) Applicant: SICK AG, Waldkirch (DE)

(72) Inventors: Thomas WEBER, Waldkirch (DE); Christoph MÄRKLE, Waldkirch (DE); Davorin JAKSIC, Waldkirch (DE)

(21) Appl. No.: 14/609,712

(22) Filed: Jan. 30, 2015

(30) Foreign Application Priority Data
Mar. 11, 2014 (DE) 102014103212.8

(51) Int. Cl. G01N 22/00

(52) U.S. Cl. CPC G01N 22/00

(57) ABSTRACT

A sensor (10) for a roller (12) of a roller track is provided which has a sensor element (24, 26) for generating a sensor signal and an evaluation unit (28) for recognizing an object (36) located at the roller track with reference to the sensor signal. The sensor (10) works according to the principle of time domain reflectometry, that is it is a TDR sensor.

The invention relates to a sensor for a roller of a roller track and to a method for recognizing objects located at a roller of a roller track with the aid of a sensor in accordance with the preambles of claims 1 and 12 respectively.

Roller tracks are as a rule used as roller conveyors in storage and conveying technology. Some of the rollers have an active drive which sets them into rotation. The remaining passive rollers can be co-moved by the active rollers via belts or the objects set into motion bridge such rollers due to inertia. To control the material flow, the roller track should be monitored for the presence of objects at specific positions of the conveying path. The most varied sensors are known for this purpose such as optical sensors, magnetic sensors, inductive sensors or capacitive sensors which are attached to the corresponding location of the conveying path to detect the conveyed products at the roller track.

The mounting of such sensors using a suitable fastening technique and cabling for connection to an energy supply and to a communication network, that is to a control unit or in a ladder network to further sensors, requires a substantial effort and/or costs, additional space requirements and an individual adjustment of the numerous separately mounted sensors. In addition, externally mounted sensors are generally prone to mechanical impairments by the environment such as contamination of or damage to the detection surfaces. The servicing effort is thereby increased and a robust housing configuration furthermore becomes necessary for the mechanical protection of the sensors.

It is therefore proposed in the prior art, for instance DE 101 31 019 A1, to integrate a sensor system directly into rollers of a roller track. The technologies named in this respect are, however, merely listed without details and each leave serious problems unsolved. For example, the availability of optical sensors frequently suffers due to contaminants. Other principles such as capacitive sensors or inductive sensors cannot reliably distinguish fluctuations of the sensor signal due to various external influences such as irregularities in the movement of the roller due to bearing play, temperature changes, wear or contamination from the effects by an object at the roller. It is also of no help here if, for example with capacitive sensors, rollers of plastic are to be excluded, since it is not explained how this could be achieved. The functional principle with respect to a likewise named embodiment having a radar transmitter or microwave transmitter is left completely open except for the mentioning of these elements.

DE 20 2007 015 529 U1 discloses a roller for a roller track having an integrated capacitive sensor which additionally provides a reference sensor on a side remote from the conveying side. With an object conveyed over the rollers, a switch signal is then determined from a difference signal between the signal of the actual sensor and of the reference sensor. It is additionally proposed to arrange a plurality of sensors behind one another in the longitudinal direction of the roller.

The principle of time domain reflectometry (TDR) is known from completely different application areas. It was originally used to localize line breaks in transoceanic cables. A signal is coupled into the line for this purpose and the signal transit time is measured until an echo returns from a discontinuity of the characteristic impedance which causes the line break. In other applications such as filling level measurement, the signal is coupled into a probe which projects into a container having medium whose filling level is to be measured. The discontinuity of the characteristic impedance is here caused by the air-to-medium transition at the level of the filling level to be determined. TDR sensors are not mentioned in connection with roller tracks in the prior art.

It is therefore the object of the invention to make possible a reliable presence detection of objects at a roller track.

This object is satisfied by a sensor for a roller of a roller track and by a method for recognizing objects located at a roller of a roller track with the aid of a sensor in accordance with the preambles of claims 1 and 12 respectively. In this respect, the invention starts from the basic idea of using a sensor in accordance with the principle of time domain reflectometry, that is a TDR sensor, as the sensor for the presence recognition of objects at the roller track. As mentioned in the introduction, TDR sensors are known per se, for example, for filling level measurement or for localizing cable breaks. TDR sensors are not conventionally used merely for presence recognition.

The invention has the advantage that the disadvantages of the previously proposed solutions are avoided by the use of a technology new to the application. A TDR sensor is, for example, unlike optical sensors, not sensitive to dust or contaminants. Unlike a capacitive sensor a TDR sensor also allows rollers of metal and does not require any dielectric so that the rollers are hard-wearing and have a long life. A particularly robust presence recognition thus becomes possible for objects at a roller track.

The sensor preferably has a transmitter and a receiver for transmitting and receiving the electromagnetic sensor signal, in particular a microwave pulse, conducted at a probe, wherein the evaluation unit is configured to recognize objects with reference to reflections of the signal conducted at the probe. The TDR sensor is thus configured to generate, detect and evaluate a sensor signal. The sensor signal is generally a curved line which contains the reflections or echoes at the discontinuities along the probe. This curved line can be sampled and then digitally assessed in its total information content, but can also be evaluated in an analog manner, for example with reference to thresholds. An evaluation with reference to reflections can contain the recognition of echoes generated by the object, but also changes of expected or of previously detected echoes.

The probe is preferably accommodated in the roller. A compact sensor is thus provided which does not include any external structures or which comprises less interfering external structures.

The roller preferably acts as the probe. A roller of the roller track is thus itself used to conduct the signals of the TDR sensor as its probe and a particularly compact design is thus achieved. The roller typically has a rigid rotatable axle and the actual roller, i.e. a cylindrical element which rotates about the axis of rotation and which in so doing conveys objects at its outer periphery. If the roller acts as a probe, the sensor signal is preferably coupled to the non-rotating rotatable axle. The coupling between the TDR sensor and the roller takes place, for example, capacitively or directly by a connection piece. The support of the roller does not represent any problem in this respect. The radio frequency wave of the sensor signal propagates easily along the roller due to the capacitive coupling or even the conductive connection. Alternatively to the use of the roller as a probe, an additional probe is in principle also conceivable; however, a number of advantages are thereby lost.

The sensor is preferably integrated into a frame of the roller track. This avoids additional elements and results in a reduced space requirement at the roller track. In strict terms, a sensor head, that is, for example, transmitter, receiver and evaluation, is integrated into the frame, not the probe. The latter is not arranged at the frame, but rather at the roller or the roller is itself the probe.

The evaluation unit is preferably configured to define the position of a reference pulse in the sensor signal and to recognize the presence of an object with reference to a shift of the reference pulse. Pulses, reflections or echoes in the sensor signal do not only arise where an object is located, but rather also at other transition points, for instance at the start or end of a roller. Such echoes can be used as reference pulses because they occur constantly and independently of the presence of an object. The measurement effect is that an object changes the dielectricity constant and thus the propagation speed of the sensor signal in its environment. The resulting shift of the constantly detectable reference pulse can frequently be evaluated more reliably than the occurrence or non-occurrence of an object echo which, for instance in the case of thin, dry objects, can be too low for a pulse recognition, in particular by means of a simple threshold evaluation.

The evaluation unit is preferably configured to determine the position of a recognized object at the roller track from a signal transit time of the sensor signal up to an object edge. The TDR principle delivers more measurement information than the mere presence which is detected in this embodiment. The object edge which is close from the viewpoint of the sensor head and also the distant object edge with a smaller amplitude can be localized on the basis of the signal transit times. This produces information on position and size of the object. This information on position and size can be refined by multiple measurement in a plurality of rollers having an integrated sensor and/or by a repeated measurement while taking account of the conveying speed.

The evaluation unit is preferably configured to determine a calibration signal in the absence of objects in advance and then to take it into account for the recognition of objects. Those influences on the sensor signal which are not caused by an object to be recognized are thus detected in a kind of blank calibration. They are then taken into account in a simple manner in operation by deducting the calibration signal from the respective sensor signal. In an embodiment which is based on the shift of a reference pulse, the signal range of the reference pulse can be excluded from the compensation by the calibration signal. On the other hand, a shift of the reference pulse caused by an object also then detectably changes the sensor signal when the calibration signal would have eliminated the reference pulse without such a shift.

The evaluation unit is preferably configured to determine or adapt the calibration signal in operation with reference to a history of sensor signals. The blank calibration without an object therefore does not only take place initially, here, but dynamically. It is ultimately preferably a filter having low-pass properties which therefore forgets fast changes by objects and influences on the sensor signal lying far in the past. The filter parameters should be set such that slowly moved objects or objects in the temporary jam do not yet trigger any adaptation, but rather only long-term effects such as deposits at the roller. An initial blank calibration can enter into the design of the filter as a factor.

In an advantageous further development, a rollers is provided having a sensor in accordance with the invention integrated therein. This roller can have its own drive, that is it can be an active roller. The sensor then preferably also utilizes the supply and control lines of this drive. The sensor can, however, also be used in a passive roller without its own drive. The sensor then requires its own connections or is supplied and communicates wirelessly. It is also conceivable to equip the sensor with a battery or with its own energy generation from the rotational movement.

The method in accordance with the invention can be designed in a similar manner by further features and shows similar advantages in this respect. Such further features are described in an exemplary, but not exclusive manner in the dependent claims following the independent claims.

The invention will also be explained in the following with respect to further advantages and features with reference to the enclosed drawing and to embodiments. The Figures of the drawing show in:

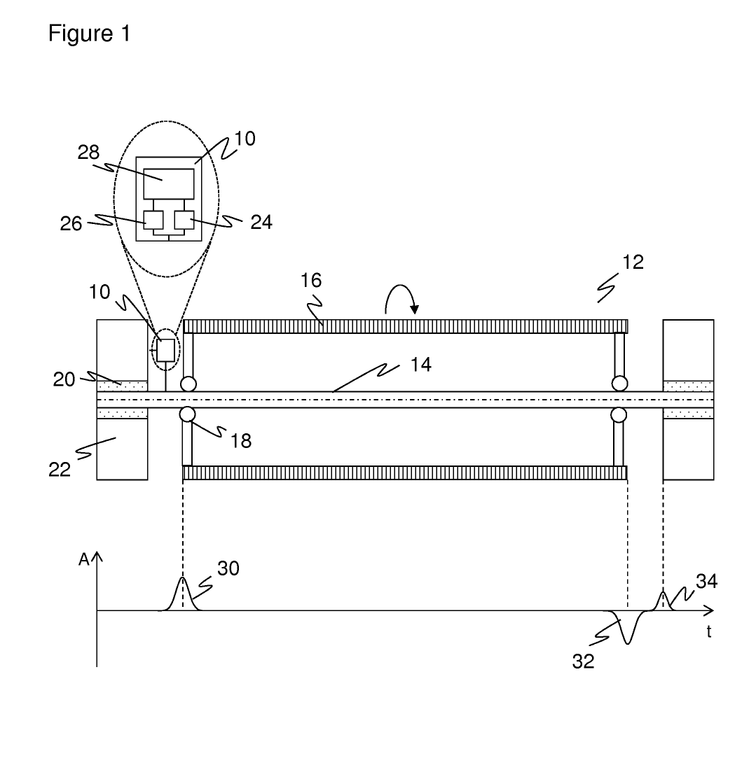

FIG. 1 a schematic sectional representation of a roller with a TDR sensor and its sensor signal in the absence of objects;

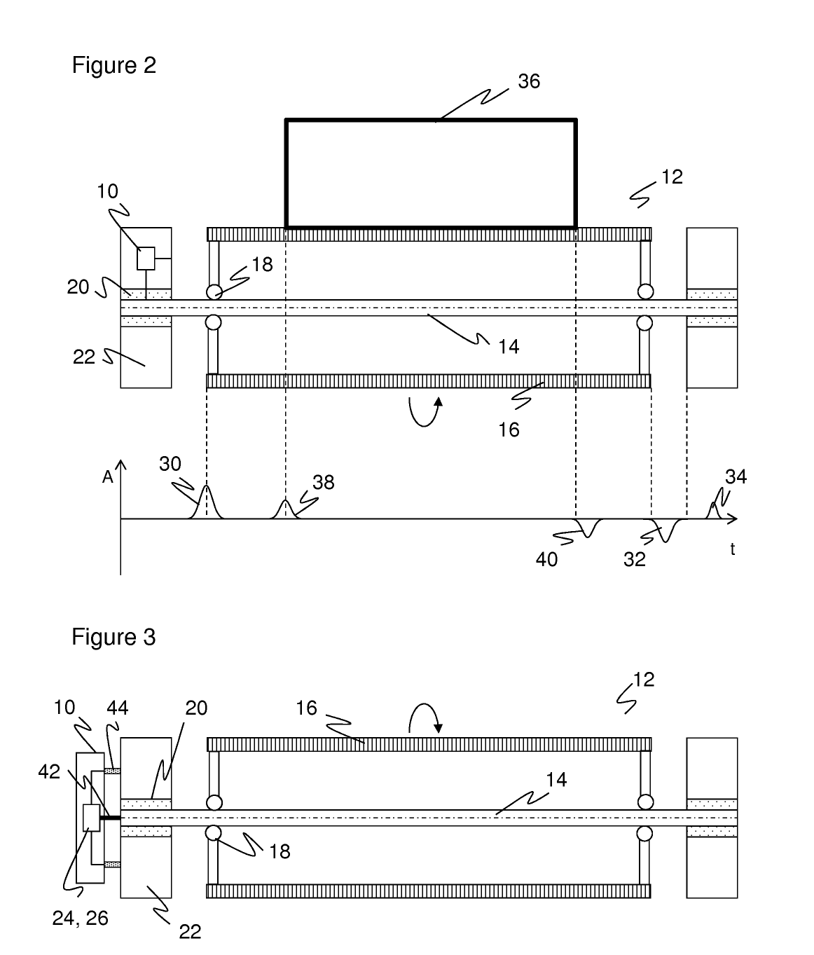

FIG. 2 a schematic sectional representation of a roller with a TDR sensor and its sensor signal in the presence of objects; and

FIG. 3 a further embodiment of a roller with a TDR sensor with a further coupling variant.

FIG. 1 shows a sectional representation of a TDR sensor 10 (TDR=time domain reflectometry) which is inserted into a roller 12 of a roller track. The roller 12 has a conductive, usually metallic rotatable axle 14 about which the actual roller element 16 of the roller 12 rotates with the aid of a ball bearing 18. The rotatable axle 14 can also rotate in other embodiments. The rotatable axle 14 is held by a frame in an insulation 20. The TDR sensor 10 couples at the rotatable axle 14, on the one hand, and at the frame 22, on the other hand.

The TDR sensor 10 is shown in FIG. 1 at its possible connection position at the roller 12 only as a small block and therefore, as illustrated by dashed lines, enlarged again above the roller 12. The sensor 10 has, as can be recognized in the sensor head shown enlarged, a transmitter 24, a receiver 26 and a control and evaluation unit 28 connected thereto.

On a measurement for the presence recognition of objects at the roller 12, a radio frequency signal, in particular a microwave pulse, is now generated by the transmitter 24 in accordance with the initially described TDR principle and is coupled to the roller 12 or to its rotatable axle 14 where it propagates as an electromagnetic wave at its surface. The radio frequency signal is partially reflected at impedance jumps and these reflections or echoes arrive via the receiver 26 at the control and evaluation unit 28 for further processing. Impedance jumps arise at objects along the propagation path, but also at elements of the roller 12 itself, with objects having a high dielectricity constant generating higher reflections that those having a small dielectricity constant. The control and evaluation unit 28 can therefore recognize present objects from the echoes and can possibly also obtain additional information, for instance the position or size of a present object, with reference to signal transit times.

The roller 12 thus itself serves as a probe of the sensor 10. The coupling of the electromagnetic waves from the sensor head to the roller 12 can be implemented very easily and in different manners, for example capacitively or by a direct line connection. The roller 12 is fastened insulated from the frame 22 by the insulation 20. The frame 22 or adjacent further rollers are used a counter-potential of the radio frequency coupling.

In the lower part of FIG. 1, an exemplary sensor signal in the absence of objects at the roller 12 is shown schematically. In this respect, the time which corresponds to the path along the roller 12, with the exception of a proportionality factor, is entered on the X axis and the amplitude of the sensor signal is entered in arbitrary units on the Y axis. At the edge of the roller 12 at the front from the viewpoint of the TDR sensor, a first roller reflection 30 is produced with an arbitrarily fixed sign; a second roller reflection 32 with the reverse sign is produced at the rear edge of the roller 12. An end reflection 34 arises at that transition of the rotatable axle 14 into the frame 20. The reflections 30, 32, 34 are accordingly not real measurement effects, but rather artifacts of the measurement environment caused by the roller 12 and its support in the frame 20.

FIG. 2 again shows for comparison the TDR sensor 10 and the roller 12, but now with an object 36 at the roller 12. As in the total description, in this respect the same features, or features corresponding to one another, are provided with the same reference numerals. In contrast to FIG. 1, the sensor head of the TDR sensor 10 in FIG. 2 is integrated into the frame and is thereby not visible from the outside. This particularly compact design is only to illustrate an advantageous embodiment variant and is of no significance for the further comparison of the situation with and without an object 36.

An exemplary sensor signal is now also shown schematically in the bottom part of FIG. 2 in the presence of the object 36 at the roller 12. The first roller reflection 30 is the same as in FIG. 1 since the object 36 does not influence the signal path up to the front edge of the roller 12. However, an additional first object reflection 38 now arises behind this at the front edge of the object 36 and an additional second object reflection 40 at the rear edge of the object 36. The second object reflection 40 is somewhat delayed and its position therefore does not coincide with the rear edge of the object 36 since the object 36 influences the propagation speed of the radio frequency signal along the roller 12. This delay also relates to the second roller reflection 32 and to the end reflection 34. In addition, the second roller reflection 32 and the end reflection 34 are reduced in amplitude with respect to FIG. 1 since an additional portion of the signal energy had already previously been reflected back by the two object reflections 38, 40.

A simple possibility of determining the presence of the object 36 is to monitor whether object reflections 38, 40 occur. This can take place by a threshold assessment, wherein the threshold is selected in the context of the desired sensitivity of the system, for instance whether small objects such as letters are to be detected, and of the interference influences such as contamination, moisture and EMC. Since, as explained, reflections 30, 32, 34 also occur without the object 36, the signal range has to be selected accordingly to preclude confusion. Furthermore, the signal curves in accordance with FIGS. 1 and 2 are idealized and interference pulses which cannot be easily distinguished from object reflections 38, 40 by a threshold can therefore also occur in the relevant region of the roller 12 due to various external influences and irregularities at the roller 12. Filters and calibrations to deal with this problem will be described below.

However, interference exclusion also in particular reaches its limits when the object 36 only slightly influences the electromagnetic field, whether this is due to a small extent or to a small dielectricity constant such as in the example of dry paper. The object reflections 38, 40 then become so small under certain circumstances that a direct pulse evaluation is no longer reliable. An alternative advantageous evaluation process which works equally for objects with considerable object reflections 38, 40 or which can be applied cumulatively therefore determines the shift of a striking reference pulse by the change of the propagation speed in the presence of the object 36. The second roller reflection 32 or the end reflection 34, for example, serves as the reference pulse. The reference pulse arises at impedance jumps of the structure of the roller 12 and remains easily recognizable independently of the properties of the object 36. If a reference pulse is selected behind possible positions of objects 36 in the propagation path of the sensor signal, this reference pulse is still robustly determined and the object 36 is detected with reference to the time delay of the reference pulse.

The TDR principle is originally a signal transit time process and is accordingly able also to measure the interval from an echo. At least the position of the front edge of the object 36 can thereby be determined from the time position of the first object reflection 38 in the sensor signal. It must be noted in the determination of the position of the rear edge of the object from the time position of the second object reflection 40 that the object 36 here already delays the signal propagation. The rear edge can therefore only be roughly estimated or can be determined using knowledge or assumptions with respect to the dielectricity constant of the object 36. The time information or the spatial information on the various echoes can moreover be used for a uniform interference exclusion. Object reflections 38, 40 can only occur in a specific region, for example not below a minimum spacing from the sensor head.

A sensor signal can initially be taught as a calibration signal or as a blank curve while no object 36 is located at the roller 12 as a possibility for the above-addressed filtration or calibration of the sensor signal. If the calibration signal is then later deducted from the respective measured sensor signal, the reflections and interference influences caused by the roller 12 itself are eliminated. It must be noted in this respect that in a method which monitors the shift of a reference pulse 32, 34 the difference formation with the calibration signal also changes or even eliminates the reference pulses. A remedy here is to exclude the range of the reference pulse 32, 34 from the difference formation or not to monitor for a shift of the reference pulse, but rather for significant changes in the expected signal range of the reference pulse 32, 34.

A calibration signal which has once been determined may not be sufficient to eliminate interference influences under certain circumstances. For example, strong dirt deposits, moisture or changes in the bearings 18 of the roller 12 can result in a significant change in the radio frequency behavior. A dynamic interference exclusion is therefore proposed in a further embodiment. A corresponding filtration can initially relate to the longitudinal extent of the roller 12 which can improve the signal-to-noise ratio.

The dynamic interference exclusion should, however, preferably take account of a history of a plurality of measurements and of the sensor signals gained in this respect. The respective calibration signal currently to be used is therefore determined in a group filtration from a plurality of early sensor signals. To reduce the storage effort, a recursive filter is conceivable which therefore determines the existing calibration signal in each case with reference to the current sensor signal or to an only brief history, for example also of the previous sensor signal.

The filter essentially works as a low-pass filter. Short-term effects such as the conveying past of objects 36 even with a slow conveying or a conveying jam and effects lying long in the past are thereby no longer taken into account. The time constants required for this purpose can easily be found since the interference to be excluded such as deposits or temperature fluctuations as a rule cause changes which are slower by orders of magnitude. It is moreover conceivable always to cancel the dynamic exclusion whenever an object 36 is just recognized. Sensor signals which were measured in the presence of objects 36 therefore do not flow into the filter at all.

Since the total measurement arrangement in the industrial environment can be exposed to substantial electromagnetic interference, measures are conceivable which make the TDR process robust toward such interference, for example a time jump process. In this respect, the sensor signal is respectively measured at pseudo-randomly other sampling points in different repetitions and the time order is subsequently reconstructed using the known random sequence. Conversely, the TDR sensor 10 should itself also observe all the required limit values for the emission of electromagnetic energy. A simple method for this is to interpose transmission breaks at specific points in time.

FIG. 3 again shows a different embodiment of the TDR sensor 10 and of the roller 12 to explain a further possibility of the attachment and coupling. In this respect, the electronics of the TDR sensor 10 are attached to the frame 22 from the outside so that the radio frequency signals can be coaxially coupled to the rotatable axle 14. A centrally arranged pin contact 42 serves as a coupling element. Resilient elements 44 are provided radially offset thereto such as seals which can conduct radio frequency and can be mounted by SMDs or mechanical spring contacts which allow a tolerance compensation.

The TDR sensor 10 was described for the example of the evaluation of echoes of a microwave pulse. The radio frequency signal is, however, neither necessarily limited to the frequency range of microwaves or to a pulse shape. Amplitude modulations not of pulse shape also produce echoes which can be evaluated as long as a point in time can be derived from the amplitude modulation such as with multiple pulses or jump functions. Alternatively to the amplitude of the radio frequency signal, its frequency (in particular FMCW processes) or phase can also be modulated. It is finally conceivable to draw a conclusion on the presence of objects 36 at the roller in a transmitting design. The transmitter 24 and the receiver 26 are in this respect not arranged on the same side of the roller 12, but rather at oppositely disposed ends. An object 36 at the roller changes the echoes which produce the signal running at the roller by impedance differences triggered by it. A conclusion can therefore also be drawn on the presence or absence of objects 36 from the transmitted signal.

What is claimed is:

1. A sensor for a roller of a roller track which has a sensor element for generating a sensor signal and an evaluation unit for recognizing an object located at the roller track with reference to the sensor signal, wherein the sensor is a TDR sensor.

2. The sensor in accordance with claim 1,
further comprising a transmitter and a receiver for transmitting and receiving the electromagnetic sensor signal conducted at a probe, wherein the evaluation unit is configured to recognize objects with reference to reflections of the signal conducted at the probe.

3. The sensor in accordance with claim 2,
wherein the electromagnetic sensor signal is a microwave pulse.

4. The sensor in accordance with claim 2,
wherein the sensor is accommodated in the roller.

5. The sensor in accordance with claim 2,
wherein the roller acts as a probe.

6. The sensor in accordance with claim 1,
wherein the sensor is integrated into a frame of the roller track.

7. The sensor in accordance with claim 1,
wherein the evaluation unit is configured to define the position of a reference pulse in the sensor signal and to recognize the presence of an object with reference to a shift of the reference pulse.

8. The sensor in accordance with claim 1,
wherein the evaluation unit is configured to determine the position of a recognized object at the roller track from a signal transit time of the sensor signal up to an object edge.

9. The sensor in accordance with claim 1,
wherein the evaluation unit is configured to determine a calibration signal in the absence of objects in advance and then to take it into account for the recognition of objects.

10. The sensor in accordance with claim 9,
wherein the evaluation unit is configured to determine or adapt the calibration signal in operation with reference to a history of sensor signals.

11. A roller having a sensor comprising a sensor element for generating a sensor signal and an evaluation unit for recognizing an object located at a roller track with reference to the sensor signal, wherein the sensor is a TDR sensor.

12. A method for recognizing objects located at a roller of a roller track with the aid of a sensor,
wherein the sensor works according to the TDR principle in that an electromagnetic sensor signal is conducted along the roller and is evaluated for influence by objects located at the roller track.

13. The method in accordance with claim 12,
wherein the electromagnetic sensor signal is a microwave pulse.
